(19) United States
(12) Patent Application Publication
(10) Pub. No.: US 2017/0081882 A1
(43) Pub. Date: Mar. 23, 2017

(54) DOOR LATCH ASSEMBLY

(71) Applicant: Thase Enterprise Co., Ltd., Taipei (TW)

(72) Inventor: Ching Tien LIN, Taipei (TW)

(21) Appl. No.: 14/857,994

(22) Filed: Sep. 18, 2015

(51) Int. Cl. E05B 65/10; E05C 9/00; E05C 19/00

(52) U.S. Cl. CPC E05B 65/1046; E05C 19/003; E05C 9/006

(57) ABSTRACT

A door latch assembly includes a push bar attached to a door panel and connected to an actuating lever which is coupled to two latchbolts with linking rods and sliding links, two rotary members pivotally mounted in a housing and coupled to the linking rods with the sliding links for forcing the sliding links to move relative to the housing, a sliding member slidably engaged in the housing and engaged with the rotary members for pivoting the rotary members relative to the housing, an actuating element is pivotally mounted to the housing and includes an engaging hole for being engaged with a tool member and for testing purposes before a handle actuated axle is engaged with the engaging hole of the actuating element.

### BACKGROUND OF THE INVENTION

1. Field of the Invention

The present invention relates to a door latch assembly for a panic exit door, and more particularly to a door latch assembly for a panic exit door including an improved and simplified structure or configuration for allowing the door latch assembly to be actuated or operated or tested without a push bar.

2. Description of the Prior Art

Various kinds of typical door latch assemblies for panic exit doors have been developed and provided for latching or locking the exit doors and comprise a push bar connected or coupled to a door latch assembly for actuating or operating the door latch assembly to lock and release the exit doors.

For example, U.S. Pat. No. 5,464,259 to Cohrs et al., U.S. Pat. No. 6,009,732 to Haeck et al., and U.S. Patent Application Publication No. 2012/0032455 A1 to Lin disclose several of the typical door latch assemblies for panic exit doors and each also comprising a door latch assembly including an upper latch device and a lower latch device for selectively latching or locking an exit door panel to a door frame, and a push bar connected or coupled to the upper latch device and the lower latch device of the door latch assembly for actuating or operating the door latch assembly to lock and release the exit doors.

However, the upper and the lower latch devices of the door latch assembly should be actuated or operated by the push bar, and thus may not be actuated or operated or tested without the push bar, such that the push bar should be assembled and connected or coupled to the upper and the lower latch devices of the door latch assembly before the door latch assembly may be actuated or operated or tested.

The present invention has arisen to mitigate and/or obviate the afore-described disadvantages of the conventional door latch assemblies.

### SUMMARY OF THE INVENTION

The primary objective of the present invention is to provide a door latch assembly including an improved and simplified structure or configuration for allowing the door latch assembly to be actuated or operated or tested without a push bar.

The other objective of the present invention is to provide a door latch assembly including an improved and simplified structure or configuration for allowing the door latch assembly to be easily and quickly assembled by the workers.

In accordance with one aspect of the invention, there is provided a door latch assembly comprising a door panel, a casing attached to the door panel, an actuating lever slidably received in the casing, a push bar attached to the casing and connected to the actuating lever and for actuating the actuating lever to move relative to the casing, a receptacle mounted to the door panel, the receptacle including a chamber formed therein, the receptacle including an orifice formed therein and communicating with the chamber of the receptacle, two brackets mounted to the receptacle, two latchbolts pivotally attached to the brackets, two linking rods slidably attached to the brackets and connected to the latchbolts respectively for actuating the latchbolts to selectively move into the brackets, a housing engaged into the chamber of the receptacle and secured to the receptacle, the housing including an aperture formed therein and aligned with the orifice of the receptacle, two rotary members pivotally mounted in the housing with the pivot shafts respectively, two sliding links slidably mounted to the housing and coupled to the linking rods and engaged with the rotary members respectively for forcing the sliding links to move up and down relative to the housing and the receptacle when the rotary members are pivoted relative to the housing, a sliding member slidably received and engaged in the housing and engaged with the rotary members for pivoting the rotary members relative to the housing when the sliding member is moved relative to the housing, the sliding member including a limb extended therefrom for engaging with the actuating lever and for allowing the sliding member to be moved relative to the housing with the actuating lever, the sliding member including a cam seat provided therein, an actuating element pivotally mounted to the housing, the actuating element including an engaging hole formed therein and aligned with the aperture of the housing and the orifice of the receptacle, the actuating element including a cam member provided thereon for engaging with the cam seat of the sliding member and for moving the sliding member relative to the housing when the actuating element is pivoted relative to the housing, and a handle pivotally attached to the door panel and coupled to an axle, the axle is engaged through the orifice of the receptacle and the aperture of the housing and engaged with the engaging hole of the actuating element for actuating the axle to rotate the actuating element relative to the housing selectively, and a tool member may be engaged with the engaging hole of the housing for testing whether the actuating element has been suitably assembled or not before the handle actuated axle is engaged with the engaging hole of the actuating element, or before the handle is pivotally attached to the door panel.

The housing includes a cap mounted to the housing, and the cap includes a groove formed therein for slidably receiving and engaging with the limb of the sliding member and for engaging with the actuating lever. The receptacle includes a channel formed therein and aligned with the groove of the cap for engaging with an end portion of the actuating lever and for allowing the end portion of the actuating lever to be engaged with the limb of the sliding member.

The sliding member includes two guide notches formed therein, and two active pins are attached to the rotary members and slidably engaged in the guide notches of the sliding member respectively for allowing the rotary members to be pivoted relative to the housing by the sliding member when the sliding member is moved relative to the housing.

The rotary members each include a follower pin engaged with the sliding link respectively for forcing the sliding link and the linking rods to move up and down relative to the housing and the receptacle when the rotary members are pivoted relative to the housing. The linking rods are each coupled to the bracket with an extension for allowing the linking rods to be adjustably coupled to the bracket.

The housing includes two guide tracks each having a guide slot formed therein, and the guide slots of the guide tracks are faced or directed toward each other for slidably engaging with the sliding member and for guiding the sliding member to move relative to the housing and for preventing the sliding member from being disengaged from the housing. The pivot shafts are attached to the guide tracks respectively for mounting the guide tracks to the housing.

The actuating element is pivotally mounted to the housing with a pivot rod, the pivot rod is rotatably engaged in the aperture of the housing and aligned with the orifice of the receptacle for engaging with the axle, and for allowing the tool member to be engaged with the engaging hole of the housing and for testing whether the actuating element has been suitably assembled or not before the handle is pivotally attached to the door panel.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial bottom plan schematic view of a door latch assembly for a panic exit door in accordance with the present invention;

FIG. 2 is a perspective view of a latch mechanism for the door latch assembly;

FIG. 3 is a partial exploded view of the latch mechanism for the door latch assembly;

FIGS. 4, 5, 6, 7 are partial perspective views of the latch mechanism for the door latch assembly;

FIG. 8 is another partial exploded view of the latch mechanism for the door latch assembly;

FIG. 9 is a perspective view illustrating the operation of the latch mechanism for the door latch assembly;

FIGS. 10, 11 are partial plan schematic views illustrating the operation of the latch mechanism for the door latch assembly; and

FIGS. 12, 13 are partial plan schematic views as seen from the opposite direction as that shown in FIGS. 10, 11, illustrating the operation of the latch mechanism for the door latch assembly.

### DETAILED DESCRIPTION OF THE PREFERRED EMBODIMENT

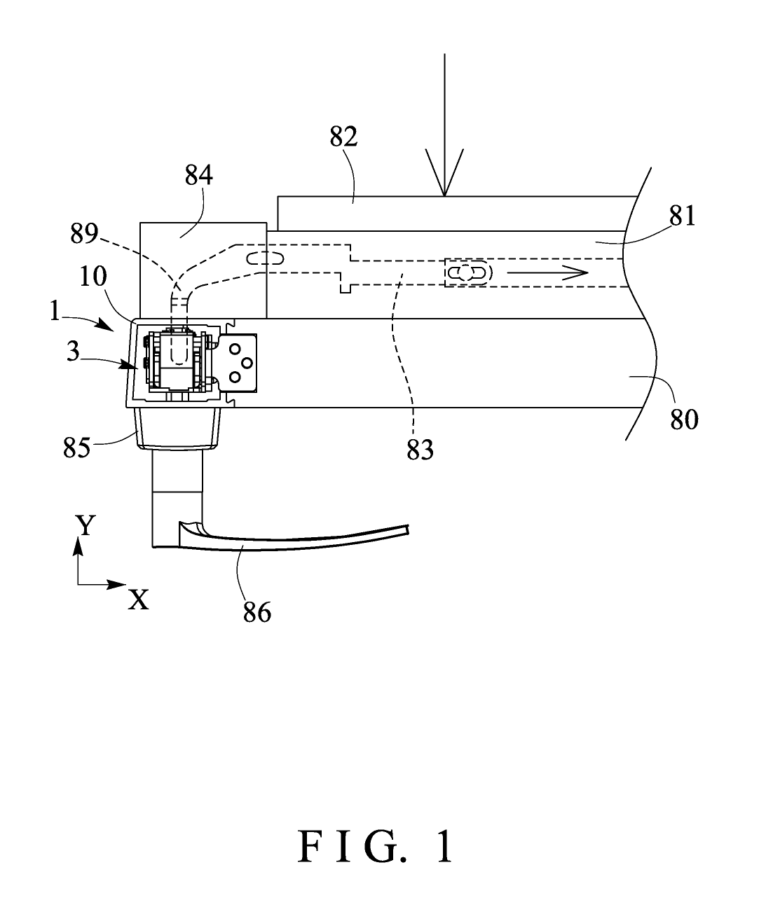

Referring to the drawings, and initially to FIGS. 1-3, a door latch assembly in accordance with the present invention comprises a latch mechanism 1 including a housing or receptacle 10 disposed or engaged into a door panel 80, such as an exit door panel 80, and preferably arranged or located at one side or edge portion of the door panel 80 (FIG. 1), and mounted or secured to the door panel 80 with screws or catches or fasteners (not illustrated) or the like, as also shown in FIG. 1, the door panel 80 includes a box or casing 81 attached or mounted to the inner or indoor portion of the door panel 80, and a push bar 82 slidably attached or mounted to the casing 81 and connected or coupled to an actuating lever 83 and for selectively actuating or operating the actuating lever 83 to slide or move relative to the casing 81 and to actuate or operate the latch mechanism 1. The above-described structure or configuration for the push bar 82 and the actuating lever 83 is typical and is not related to the present invention and will not be described in further details.

The receptacle 10 includes a compartment or chamber 11 formed therein, and includes one or more (such as two) flaps or ears 12 extended laterally and outwardly therefrom for mounting or securing the receptacle 10 to the door panel 80. The door panel 80 further includes a cover 84 also attached or mounted to the inner or indoor portion of the door panel 80 and disposed and arranged or located beside the casing 81 for covering or shielding or protecting the actuating lever 83, and a shield 85 attached or mounted to the outer or outdoor portion of the door panel 80 and/or attached or mounted to the receptacle 10, a hand grip or handle 86 is pivotally or rotatably attached or mounted to the shield 85 or the door panel 80 and connected or coupled to an axle 87 which is engaged into the chamber 11 of the receptacle 10. One or more (such as two) latch rods 88 are attached or mounted to the shield 85 and engaged into the chamber 11 of the receptacle 10 for mounting or securing the shield 85 and the handle 86 to the receptacle 10.

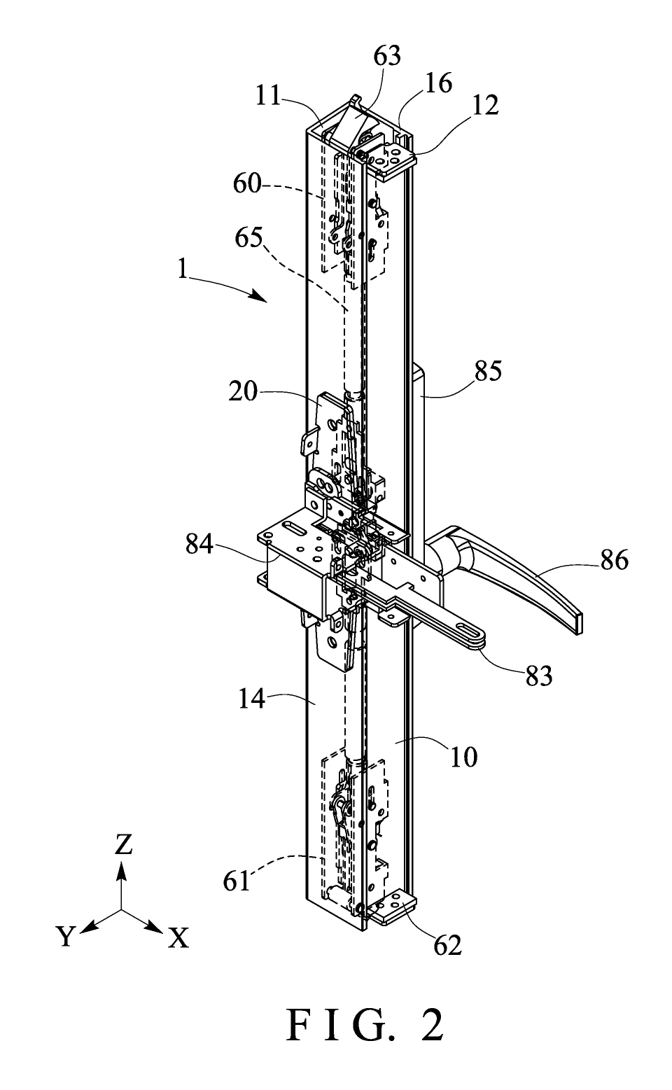

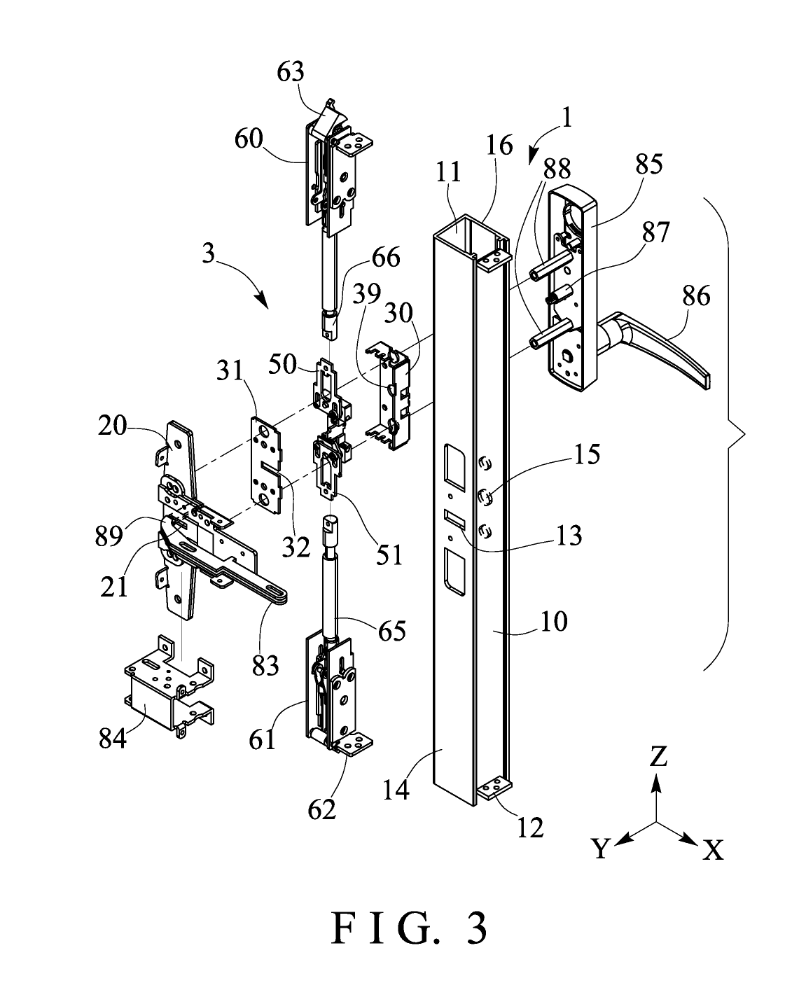

The receptacle 10 includes a channel 13 formed in one of the side portions 14 of the receptacle 10 (FIG. 3) for slidably receiving or engaging with an end portion 89 of the actuating lever 83 (FIGS. 1-3 and 9), and includes an orifice 15 formed in other or opposite portions 16 of the receptacle 10 (FIG. 3) and communicating with the chamber 11 of the receptacle 10 for receiving or engaging with the axle 87 and for allowing the axle 87 to be engaged into the chamber 11 of the receptacle 10. As shown in FIGS. 2 and 3, a base plate 20 is mounted or secured to one side of the receptacle 10, or may be disposed or engaged into the chamber 11 of the receptacle 10, and the base plate 20 includes a passage 21 formed therein (FIG. 3) and aligned with or communicating with the channel 13 of the receptacle 10 for slidably receiving or engaging with the end portion 89 of the actuating lever 83, and for allowing the end portion 89 of the actuating lever 83 to be engaged into the chamber 11 of the receptacle 10. The cover 84 may be mounted or secured to the base plate 20 and/or the receptacle 10.

The latch mechanism 1 includes a latch or transmitting device 3 having a box or housing 30 (FIGS. 3, 5) disposed or engaged into the chamber 11 of the receptacle 10 and mounted or secured to the receptacle 10 with screws or catches or fasteners or the latch rods 88, a cap 31 is mounted or secured to the housing 30 and includes a groove 32 formed therein and aligned with or communicating with the passage 21 of the base plate 20 and the channel 13 of the receptacle 10 for slidably receiving or engaging with the end portion 89 of the actuating lever 83. The housing 30 includes an aperture 39 formed therein (FIG. 3) and aligned with or communicating with the orifice 15 of the receptacle 10 for receiving or engaging with the axle 87 and for allowing the axle 87 to be engaged into the housing 30.

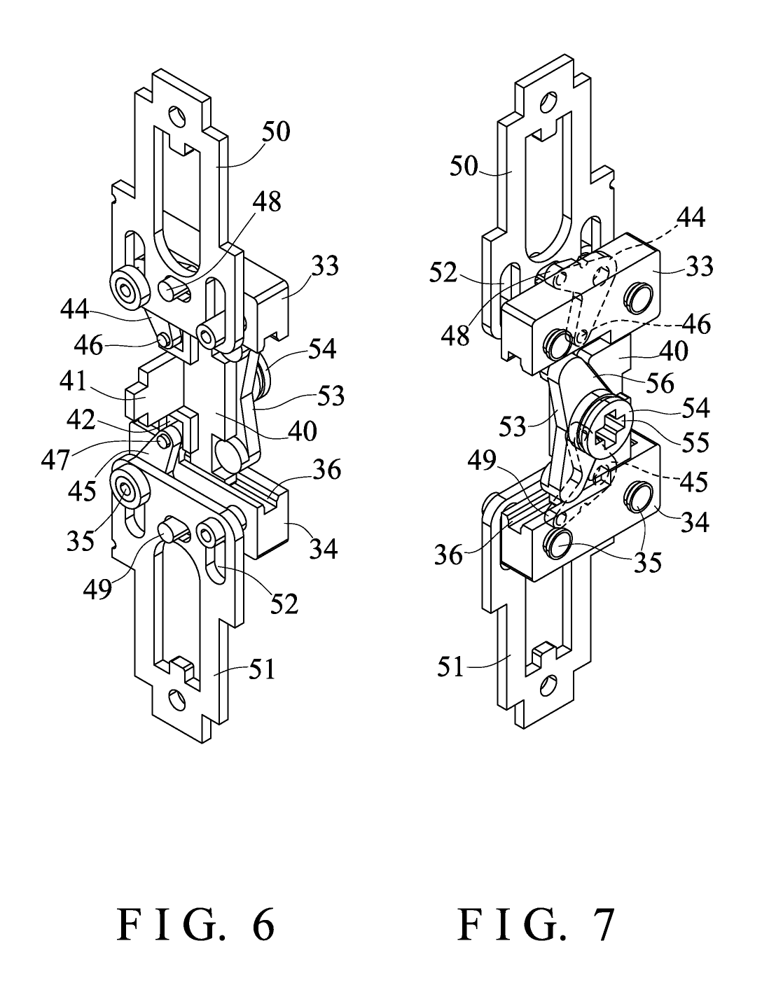

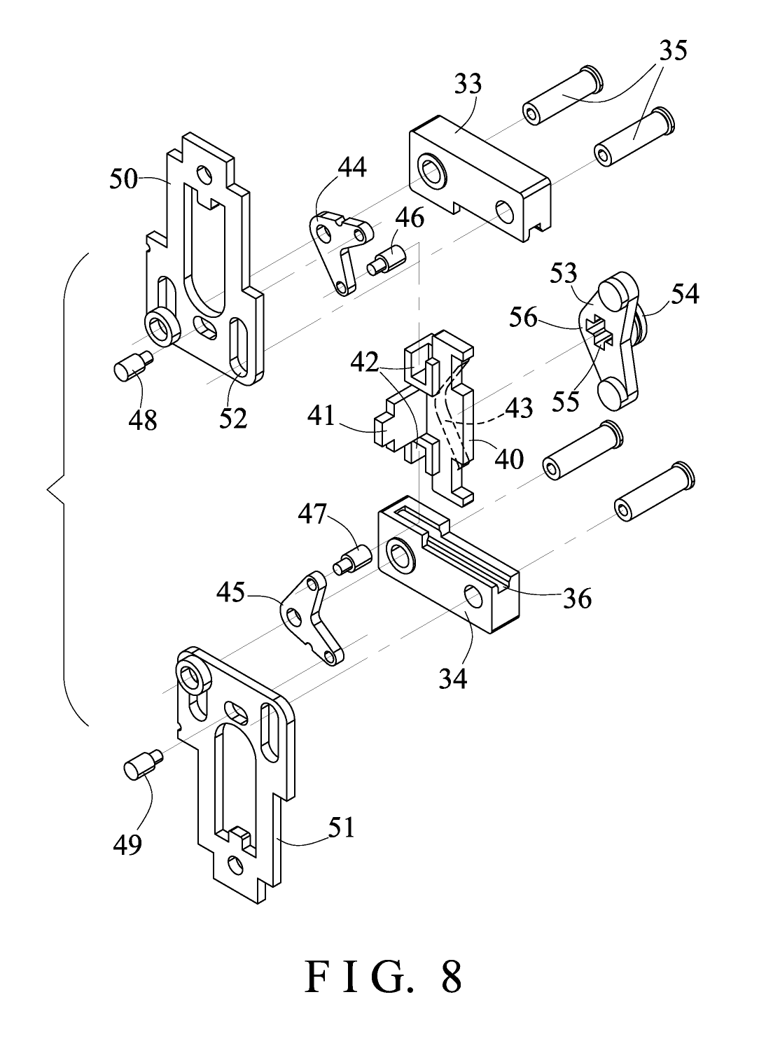

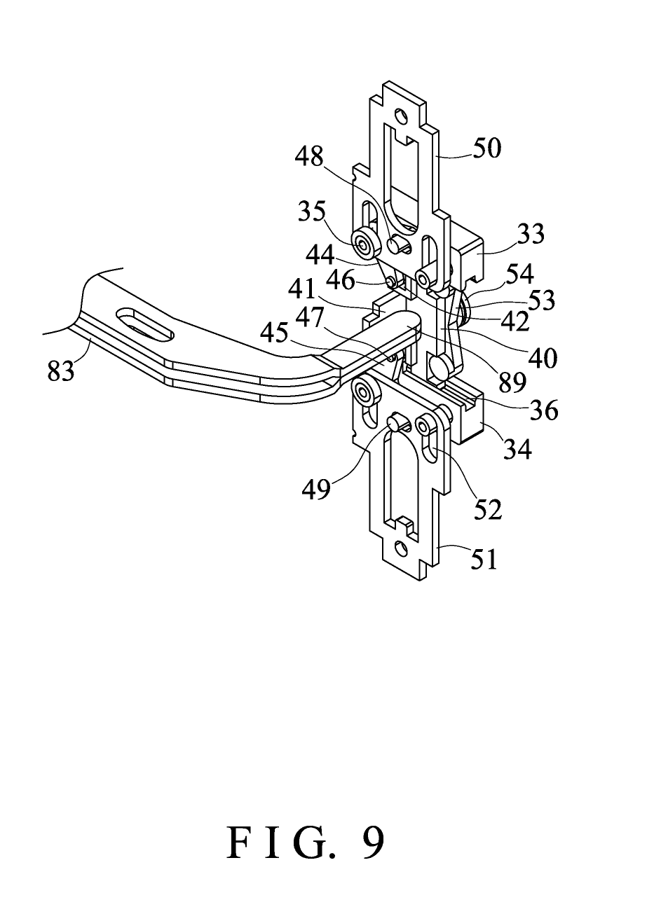

One or more (such as two) guide tracks 33, 34 are each mounted or secured in the housing 30 with one or more (such as two) pivot shafts 35, and each include a guide slot 36 formed therein, and the guide slots 36 of the guide tracks 33, 34 are faced or directed toward each other for slidably receiving or engaging with a follower or sliding member 40 (FIGS. 5-13) and for guiding the sliding member 40 to slide or move relative to the housing 30 along a lateral or X-axis (FIGS. 2, 3), the sliding member 40 includes a leg or limb 41 extended therefrom and slidably received or engaged in the groove 32 of the cap 31 or of the housing 30 (FIG. 5) and/or in the passage 21 of the base plate 20 for being contacted or engaged with the end portion 89 of the actuating lever 83 (FIG. 9) and for allowing the sliding member 40 to be actuated or moved relative to the housing 30 along the lateral or X-axis with the actuating lever 83 (FIG. 1). The sliding member 40 includes two guide notches 42 formed therein (FIGS. 5-6, 8) and faced or directed away from each other, and includes a curved or concaved guide or cam seat 43 formed or provided therein (FIGS. 8, 12-13).

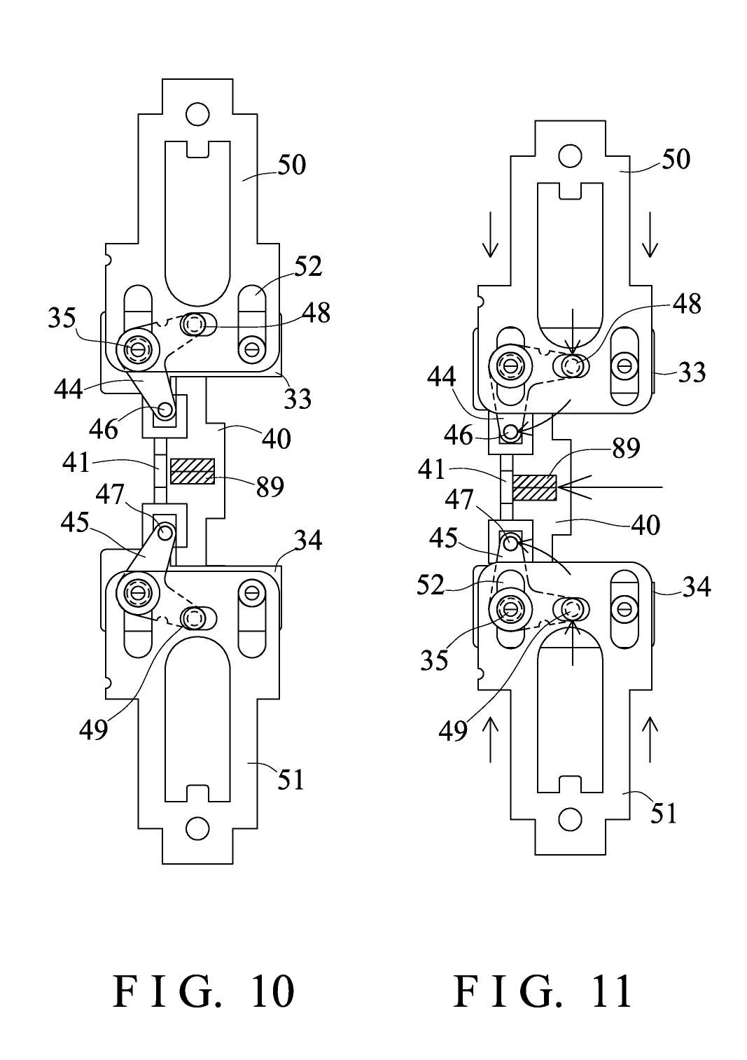

Two rotary members 44, 45 are pivotally or rotatably attached or mounted to the guide tracks 33, 34 and/or the housing 30 with the pivot shafts 35 respectively, for example, and the rotary members 44, 45 each include an active or first pin 46, 47 attached or mounted thereto and offset from the pivot shafts 35 and slidably received or engaged in the guide notches 42 of the sliding member 40 respectively for allowing the rotary members 44, 45 to be pivoted or rotated relative to the guide tracks 33, 34 and/or the housing 30 with or by the sliding member 40 when the sliding member 40 is moved relative to the housing 30 with or by the end portion 89 of the actuating lever 83 (FIGS. 10-11). The rotary members 44, 45 each further include a follower or second pin 48, 49 attached or mounted thereto and offset from the pivot shaft 35 and the active or first pin 46, 47.

Two sliding links 50, 51 are slidably attached or mounted to the housing 30 with the pivot shafts 35, for example, the sliding links 50, 51 each include one or more (such as two) longitudinal or oblong holes 52 formed therein for slidably receiving or engaging with the pivot shafts 35 respectively and for guiding or limiting the sliding links 50, 51 to move up and down relative to the housing 30 and the receptacle 10 (FIGS. 10-13). The second pins 48, 49 of the rotary members 44, 45 are engaged with the sliding links 50, 51 respectively for forcing the sliding links 50, 51 to move up and down relative to the housing 30 and the receptacle 10 when the rotary members 44, 45 are pivoted or rotated relative to the guide tracks 33, 34 and/or the housing 30.

Another rotary member or actuating element 53 is pivotally or rotatably attached or mounted to the housing 30 with a pivot rod 54 (FIG. 5), for example, the pivot rod 54 is pivotally or rotatably engaged in the aperture 39 of the housing 30 and aligned with the orifice 15 of the receptacle 10 for receiving or engaging with the axle 87. For example, the actuating element 53 includes a non-circular engaging hole 55 formed therein and also formed through the pivot rod 54 (FIGS. 7-8, 12-13) for engaging with the axle 87 and for allowing the actuating element 53 to be pivoted or rotated relative to the housing 30 with or by the axle 87. Alternatively, before the shield 85 and the handle 86 and the axle 87 are attached or mounted to the door panel 80 and/or the receptacle 10, a screw driver or tool member (not illustrated) or the like may also be engaged into the orifice 15 of the receptacle 10 and engaged with the non-circular engaging hole 55 of the actuating element 53 for selectively rotating the actuating element 53 in a testing procedure.

The actuating element 53 includes a curved or convex guide or cam surface or cam member 56 formed or provided thereon (FIGS. 7-8, 12-13) for selectively contacting or engaging with the cam seat 43 of the sliding member 40 and for selectively actuating or operating or moving the sliding member 40 along the lateral or X-axis or along the guide tracks 33, 34 when the actuating element 53 is pivoted or rotated relative to the guide tracks 33, 34 and/or the housing 30. In operation, and before the shield 85 and the handle 86 and the axle 87 are attached or mounted to the door panel 80 and/or the receptacle 10, the screw driver or tool member (not illustrated) may be engaged into the orifice 15 of the receptacle 10 and engaged with the non-circular engaging hole 55 of the actuating element 53 for selectively rotating the actuating element 53 and for testing whether the actuating element 53 of the transmitting device 3 has been suitably assembled or not. The axle 87 and the shield 85 and the handle 86 may then be easily and quickly assembled or attached or mounted to the door panel 80 and/or the receptacle 10.

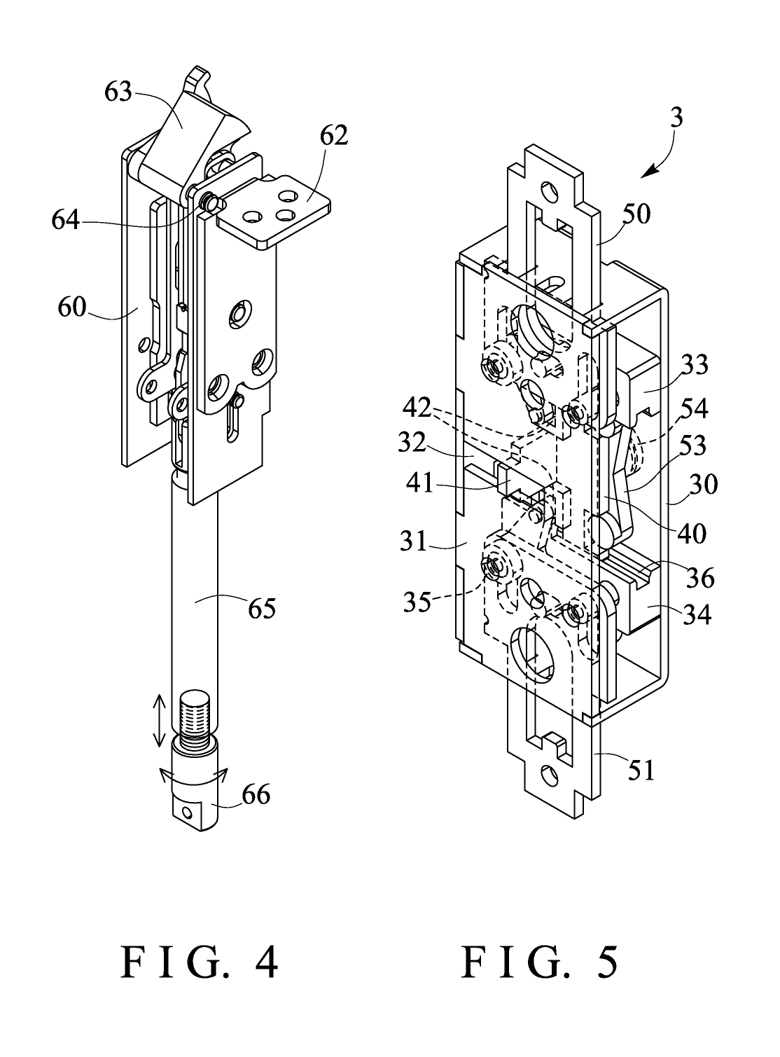

As shown in FIGS. 2-4, two brackets 60, 61 are disposed or engaged into the chamber 11 of the receptacle 10 and mounted or secured to the receptacle 10 with catches or fasteners (not illustrated) or the like, and the brackets 60, 61 each include an ear or flap 62 extended laterally and outwardly therefrom for contacting or engaging with the ears 12 of the receptacle 10 respectively and for mounting or securing the brackets 60, 61 to the receptacle 10 and the door panel 80. The brackets 60, 61 each include a latchbolt 63 pivotally or rotatably attached or mounted thereto with a pivot pin 64, and a linking rod 65 slidably attached or mounted to the respective bracket 60, 61 and connected or coupled to the latchbolt 63 for selectively actuating or moving the latchbolt 63 to move into the respective bracket 60, 61 and to selectively engage with a door frame (not illustrated). The latchbolts 63 are normally moved out of the brackets 60, 61 and the receptacle 10 for engaging with the door frame and for latching or locking the door panel 80 to the door frame. The linking rods 65 may be directly connected or coupled to the respective bracket 60, 61, or indirectly connected or coupled to the respective bracket 60, 61 with an extension 66 for allowing the latchbolt 63 to be suitably actuated or operated by the bracket 60, 61.

In operation, as shown in FIG. 1, when the push bar 82 is pushed toward the casing 81 and to move the actuating lever 83 rightwardly, the end portion 89 of the actuating lever 83 (FIGS. 9, 10) which is contacted or engaged with the limb 41 of the sliding member 40 may actuate or move the sliding member 40 leftwardly relative to the housing 30 along the lateral or X-axis with the actuating lever 83, and may pivot or rotate the rotary members 44, 45 relative to the guide tracks 33, 34 and/or the housing 30 in order to force the sliding links 50, 51 to move toward each other, and thus for forcing or moving the linking rods 65 toward each other (FIG. 11) and to actuate or move the latchbolts 63 to move into the brackets 60, 61 and to be selectively disengaged from the door frame (not illustrated), and thus for allowing the door panel 80 to be released or opened relative to the door frame from indoors.

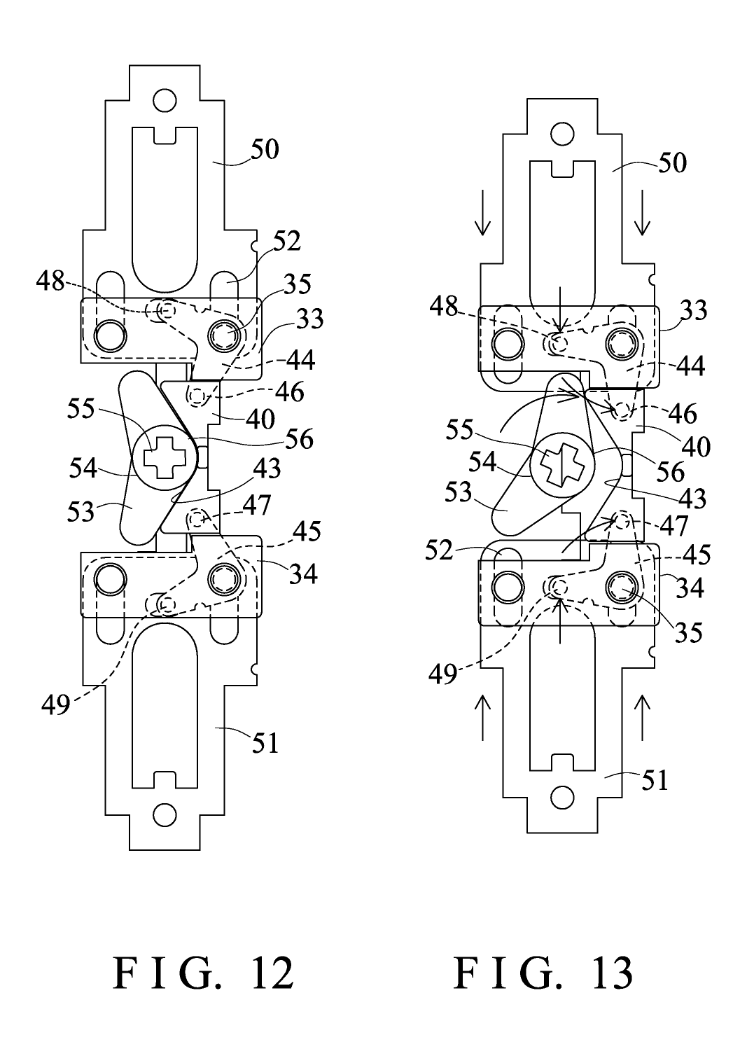

On the contrary, as shown in FIGS. 1 and 2, when the handle 86 that is located at the outdoor portion of the door panel 80 is pressed or rotated or actuated or operated by the user, as shown in FIGS. 12-13, the actuating element 53 may be pivoted or rotated relative to the housing 30 and the sliding member 40 with or by the axle 87, and may force and move the sliding member 40 rightwardly with or by the engagement between the cam member 56 of the actuating element 53 and the cam seat 43 of the sliding member 40 for allowing the sliding member 40 to be moved rightwardly (FIG. 13), and may pivot or rotate the rotary members 44, 45 relative to the guide tracks 33, 34 and/or the housing 30 in order to force the sliding links 50, 51 to move toward each other, and thus for forcing or moving the linking rods 65 toward each other (FIG. 11) and to actuate or move the latchbolts 63 to move into the brackets 60, 61 and to be selectively disengaged from the door frame.

Accordingly, the door latch assembly in accordance with the present invention includes an improved and simplified structure or configuration for allowing the door latch assembly to be actuated or operated or tested without a push bar, and for allowing the door latch assembly to be easily and quickly assembled by the workers or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door latch assembly comprising:
a door panel,
a casing attached to said door panel,
an actuating lever slidably received in said casing,
a push bar attached to said casing and connected to said actuating lever and for actuating said actuating lever to move relative to said casing,
a receptacle mounted to said door panel, said receptacle including a chamber formed therein, said receptacle including an orifice formed therein and communicating with said chamber of said receptacle,
two brackets mounted to said receptacle,
two latchbolts pivotally attached to said brackets,
two linking rods slidably attached to said brackets and connected to said latchbolts respectively for actuating said latchbolts to selectively move into said brackets,
a housing engaged into said chamber of said receptacle and secured to said receptacle, said housing including an aperture formed therein and aligned with said orifice of said receptacle,
two rotary members pivotally mounted in said housing with said pivot shafts respectively,
two sliding links slidably mounted to said housing and coupled to the linking rods respectively and engaged with said rotary members respectively for forcing said sliding links to move up and down relative to said housing and said receptacle when said rotary members are pivoted relative to said housing,
a sliding member slidably received and engaged in said housing and engaged with said rotary members for pivoting said rotary members relative to said housing when said sliding member is moved relative to said housing, said sliding member including a limb extended therefrom for engaging with said actuating lever and for allowing said sliding member to be moved relative to said housing with said actuating lever, said sliding member including a cam seat provided therein,
an actuating element pivotally mounted to said housing, said actuating element including an engaging hole formed therein and aligned with said aperture of said housing and said orifice of said receptacle, said actuating element including a cam member provided thereon for engaging with said cam seat of said sliding member and for moving said sliding member relative to said housing when said actuating element is pivoted relative to said housing, and
a handle pivotally attached to said door panel and coupled to an axle, said axle being engaged through said orifice of said receptacle and said aperture of said housing and engaged with said engaging hole of said actuating element for actuating said axle to rotate said actuating element relative to said housing selectively.

2. The door latch assembly as claimed in claim 1, wherein said housing includes a cap mounted to said housing, and said cap includes a groove formed therein for slidably receiving and engaging with said limb of said sliding member.

3. The door latch assembly as claimed in claim 2, wherein said receptacle includes a channel formed therein and aligned with said groove of said cap for engaging with an end portion of said actuating lever.

4. The door latch assembly as claimed in claim 1, wherein said sliding member includes two guide notches formed therein, and two active pins attached to said rotary members and slidably engaged in said guide notches of said sliding member respectively for allowing said rotary members to be pivoted relative to said housing by said sliding member when said sliding member is moved relative to said housing.

5. The door latch assembly as claimed in claim 1, wherein said rotary members each include a follower pin engaged with said sliding link respectively for forcing said sliding link to move up and down relative to said housing and said receptacle when said rotary members are pivoted relative to said housing.

6. The door latch assembly as claimed in claim 1, wherein said linking rods are each coupled to said bracket with an extension.

7. The door latch assembly as claimed in claim 1, wherein said housing includes two guide tracks each having a guide slot formed therein, and said guide slots of said guide tracks are directed toward each other for slidably engaging with said sliding member and for guiding said sliding member to move relative to said housing.

8. The door latch assembly as claimed in claim 7, wherein said pivot shafts are attached to said guide tracks respectively.

9. The door latch assembly as claimed in claim 1, wherein said actuating element is pivotally mounted to said housing with a pivot rod, said pivot rod is rotatably engaged in said aperture of said housing and aligned with said orifice of said receptacle for engaging with said axle.
